(19) United States
(12) Patent Application Publication
(10) Pub. No.: US 2012/0233499 A1
(43) Pub. Date: Sep. 13, 2012

(54) Device for Improving the Fault Tolerance of a Processor

(75) Inventors: Guy ESTAVES, Rabastens (FR); Fabian TOURTEAU, Fonsorbes (FR)

(73) Assignee: THALES, Neuilly-sur-Seine (FR)

(21) Appl. No.: 13/413,308

(22) Filed: Mar. 6, 2012

(30) Foreign Application Priority Data
Mar. 8, 2011 (FR) 11 00688

(51) Int. Cl. G06F 11/07

(52) U.S. Cl. 714/23; 714/E11.023

(57) ABSTRACT

A device for improving the fault tolerance of a processor installed on a motherboard, the motherboard comprising memory units and a data input/output interface, the processor being able to execute at least one application, includes: a software layer, called a hypervisor, centralizing exchanges between the said processor and the said application and implementing fault tolerance management mechanisms, and a programmable electronic component forming an interface between the processor on the one hand.

### CROSS-REFERENCE TO RELATED APPLICATION

This application claims priority to foreign French patent application No. FR 1100688, filed on Mar. 8, 2011, the disclosure of which is incorporated by reference in its entirety.

### FIELD OF THE INVENTION

The invention relates to the use of processors in space and more specifically to the use of a device for improving the fault tolerance of processors used under such conditions.

### BACKGROUND

The use of a processor in space necessitates controlling its tolerance to faults and, in particular, to errors documented as SEUs (Single Event Upsets) and SEFIs (Single Event Functional Interrupts).

An SEU event corresponds to a change in state of a bit (an elementary item of information) inside the processor caused by a particle, for example a heavy ion.

An SEFI event corresponds to a locking state of the processor. This event can be a direct consequence of an SEU event that has brought about a change in behaviour of the processor.

Processors suitable for use in a space environment are already known. However, these processors offer lower processing capacities than commercially available processors and, furthermore, they are expensive.

### SUMMARY OF THE INVENTION

The invention aims to overcome the problems cited above by proposing a device for improving the fault tolerance of a processor that is not envisaged for space applications, allowing the costs related to integrating a processor in a spacecraft to be reduced while ensuring a good resistance against SEU or SEFI events.

To this end, an object of the invention is a device for improving the fault tolerance of a processor installed on a motherboard, the said motherboard comprising memory units and a data input/output interface, the said processor being able to execute at least one application, the said device being characterized in that it includes:
a software layer, called a hypervisor, centralizing exchanges between the said processor and the said application and implementing fault tolerance management mechanisms, and
a programmable electronic component forming an interface between the said processor on the one hand, and the memory units and the input/output interface on the other hand.

Advantageously, one of the fault tolerance mechanisms implemented by the hypervisor is a function to return the processor to a known state, the said function being called upon periodically according to a configurable period, the return of the processor to a known state being triggered by a reset signal transmitted by the programmable electronic component.

Advantageously, the device for improving fault tolerance additionally comprises, means for saving a processing context of the processor, and means for restoring the saved processing context, the said means being used jointly to save a context before an execution of the function to return the processor to a known state and to restore the said context after the said function is executed, the means for saving the processing context of the processor being triggered when the processor receives a pre-initialization signal transmitted at a predetermined time period before the reset signal is transmitted.

Advantageously, the hypervisor is able to manage the simultaneous execution of several instances of the said application.

Advantageously, the device for improving fault tolerance additionally comprises:
means for recording exchanges between each of the instances of the said executed application and of the said processor, the means recording function call sequences being implemented by the hypervisor,
means for comparing the said recorded exchanges corresponding to the various instances.

According to one variant of the invention, the said processor comprises a single processing core.

According to another variant of the invention, the said processor comprises a plurality of processing cores.

Advantageously, each instance is executed on a different processing core.

Advantageously, the hypervisor additionally comprises a timeout function for transmitting a timeout request signal to a programmable electronic component in response to the reception of the pre-initialization signal, having the effect of obtaining a time delay in addition to the predetermined time period, before the reset signal is transmitted.

Advantageously, the device for improving fault tolerance comprises a watchdog mechanism, the hypervisor sending at a regular interval a signal to the said watchdog to notify it that it is operating correctly, in the absence of such a signal at the end of a predefined time period, the said watchdog resetting the processor executing the software part of the hypervisor.

The invention allows the use of commercially available processors, such as PowerPCs or DSPs (Digital Signal Processors) for space applications. Although these processors are not envisaged for such applications, the invention provides for managing SEU or SEFI events.

The hypervisor takes full charge of these events. This has the effect of simplifying development of applications intended to be executed on the processor and which do not need to implement fault tolerance mechanisms.

Furthermore, the hypervisor is sufficiently generic to be developed only once and reused on different projects.

### BRIEF DESCRIPTION OF THE DRAWINGS

The invention will be better understood and other advantages will become clear upon reading the detailed description given by way of non-limiting example and with the aid of the drawings in which:

FIG. 1 represents an example embodiment of the device according to the invention at hardware level.

FIG. 2 represents an example embodiment of the device according to the invention at software level.

FIG. 3 represents an example execution of an application on a processor implementing the device according to the invention.

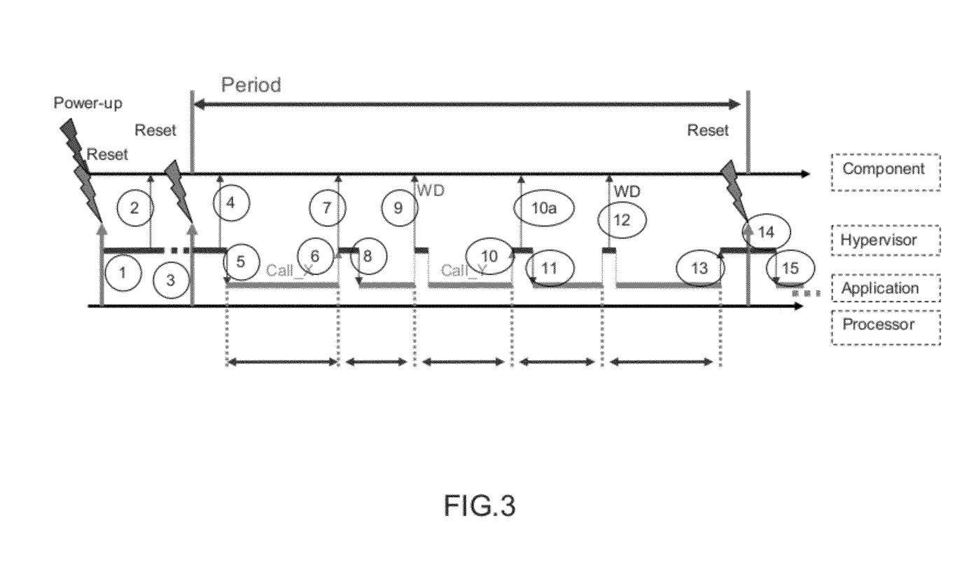

### DETAILED DESCRIPTION

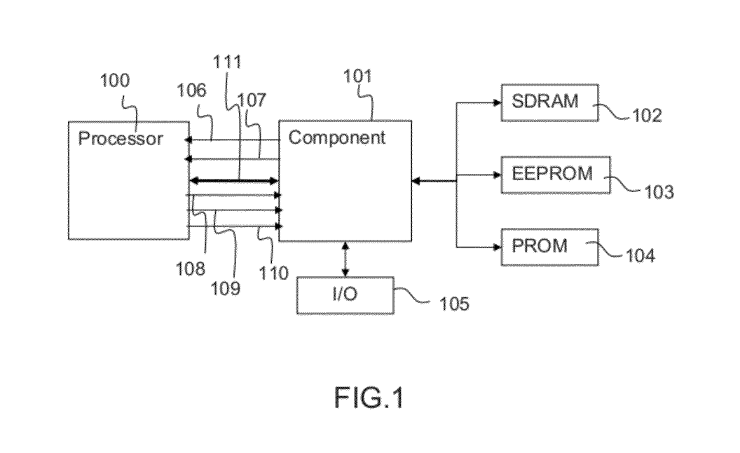

An example embodiment of the device according to the invention is presented in FIG. 1.

A processor 100 is installed on a motherboard on which there are installed:
SDRAM (Synchronous Dynamic Random Access Memory) 102,
EEPROM (Electrically Erasable Programmable Read-Only Memory) 103,
PROM (Programmable Read-Only Memory) 104,
a data input/output interface 105 communicating with the outside,
a programmable electronic component 101 forming an interface between the processor 100 on the one hand, and the memory units and the input/output interface on the other hand; in the example, it is an FPGA or ASIC electronic component developed using a radiation-tolerant technology.

The processor 100 can be described as “conventional”, i.e. not specialized for space applications.

The SDRAM memory 102 is protected by an EDAC (Error Detection and Correction) mechanism or by redundancy (generally a triplication associated with a voting system).

The programmable electronic component 101 comprises a Memory Management Unit (MMU) which segments the addressable memory space (SRAM, SDRAM, PROM, EEPROM, etc). The segmentation divides the memory into segments which are identified by an address and provides for isolating the various programs from one another.

The processor 100 comprises:
a first-level cache memory (L1) including a protection mechanism based on parity bits,
a second-level memory also including a protection mechanism either based on parity bits or based on an Error-Correcting Code (ECC).

The processor 100 can have hardware virtualization features (such as the additional supervisor mode of execution at processor level, management of virtual memory, the virtualization of input/output peripheral devices). If this is not the case, the memory management function (block protection unit, memory management unit) can be implemented in the programmable electronic component 101 which then offers the possibility of segmenting and protecting the memory addressed by the processor 100.

The processor 100 and the programmable electronic component 101 communicate via a data bus 111 providing for, notably, transmitting the various signals 106, 107, 108, 109, 110 described below.

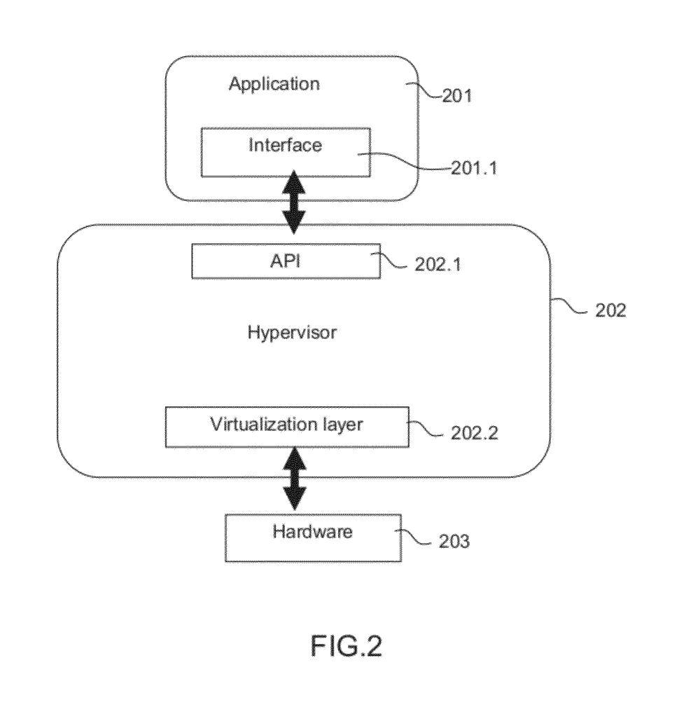

FIG. 2 represents an example embodiment of the device according to the invention at software level. The device comprises a software layer, called a hypervisor 202 or software supervisor, centralizing exchanges between the hardware resources 203 (the processor 100, the programmable electronic component 101, the memories, the input/output peripheral devices on the processor board) and the application 201 and implementing fault tolerance management mechanisms.

All the exchanges between the processor 100 and “the rest of the world”, i.e. the other electronic components 203 and the executed application 201, pass through the hypervisor. In particular, it is the hypervisor which manages the data exchanges (acquisition and production of data) with the outside (the data transiting through the inputs/outputs).

From the point of view of the executed application, the hypervisor virtualizes the hardware resources (registers of the processor, memories and inputs/outputs). The hypervisor includes a virtualization layer 202.2 provided for this purpose. The hypervisor offers interface functions (APIs) 202.1 allowing the application 201 to access the hardware resources (processor, memories, etc).

The hypervisor manages events at processor level and, in particular, interrupts.

The hypervisor is executed from a programmable memory accessible only in read-only mode (PROM: Programmable Read-Only Memory) so as to ensure that its code is not altered.

The hypervisor 202 is executed on the processor 100.

The hypervisor manages the resources of the processor such as the parity bits of the first-level cache memory (L1) and the error correction mechanisms (ECC) of the second-level cache memory (L2). Thus, the hypervisor delivers correct information to the application being executed in the event of a parity error or a single EDAC error due to an SEU at cache memory level. The executed application does not have to manage this type of error but can subscribe to a service at the hypervisor for being informed of this type of error.

The error recovery strategies are implemented at hypervisor level.

The hypervisor is activated by: calls to its API by the application being executed or asynchronous events from hardware such as an interrupt (for example generated by a timer or input/output peripheral devices).

The hypervisor comprises a watchdog mechanism to check its own operation.

The hypervisor sends, at a regular interval, a signal to the watchdog to notify it that it is operating correctly. The signal is represented by the signal 109 in FIG. 1 between the processor 100 and the programmable electronic component 101. In the absence of such a signal at the end of a predefined time period, the watchdog resets the processor 100 executing the software part of the hypervisor 202. By this mechanism, a hardware and/or software lock state can be rectified.

According to one feature of the invention, the device for improving the fault tolerance of a processor comprises a mechanism for returning the processor to a known state, also called reset.

This mechanism provides for attributing to all the elements of the processor that can change state (internal memories, flip-flops, registers) a value or a predetermined state.

This mechanism is triggered regularly. It provides for avoiding inconsistent states in the processor such as a register that changes value when it should not. This change of value is caused, for example, by the reception of a heavy ion striking this register.

In order to make the mechanism transparent for applications executed on the processor, the device comprises a register for indicating the source of the return of the processor to a known state and a function for saving and restoring the context of the processor. This function provides for copying into a reliable memory the values of all the accessible registers of the processor (forming its saved context) in order to save them, and then provides for copying them back in the other direction, i.e. from this reliable memory to the corresponding registers of the processor, in order to restore the previously saved values (restoration of the context).

Specifically, the return of the processor to a known state can be triggered for other reasons, for example:
by the watchdog mechanism,
or due to an error, triggered when the application 201 is being executed, this error being able to be, for example, an incorrect memory access, a write attempt to a write-protected area, a read access attempt to a read-protected area for the application 201, etc.

In practice, a reset can be implemented as follows:
1. transmission of a first signal 106 by the component 101 indicating to the hypervisor that a reset will be carried out;
2. saving of the processor context by the hypervisor;
3. writing to the register that the reset is a periodic reset;
4. transmission of a second signal 107 triggering the execution of the reset function;
5. reading of the register by the hypervisor to determine the source of the reset;
6. restoration of the processor context by the hypervisor.

The hypervisor is also activated when this reset mechanism is triggered.

The reset mechanism can be programmed by the hypervisor. Its activation frequency is set according to the mission planned for the spacecraft. It can range, for example, from one millisecond to several minutes.

According to one feature of the invention, the hypervisor comprises means for executing in parallel several instances of an application. For example, executing two or three instances of the same application results in improving the fault tolerance, notably by comparing the execution results of the various instances. If only two instances are executed, if the results of the two instances diverge, then the hypervisor detects an inconsistency. If three instances are executed, if the results of two instances differ, the result of the third is used to determine the expected result. The three instances are generally compared by a voting mechanism.

According to a preferred embodiment, when several instances of the same application are executed in parallel, the device for improving the fault tolerance of a processor also comprises:
means for recording exchanges between each of the instances of the executed application and the processor, the means recording function call sequences being implemented by the hypervisor,
means for comparing the recorded exchanges corresponding to the various instances.

The hypervisor thus regularly checks the progress of each instance through the information recorded for each of them. In a three-instance configuration, when the recorded information of one partition differs from the other two, the hypervisor can decide to stop the partition which is behaving differently and restart its execution from a valid context determined from the other two instances. In a two-instance configuration, the hypervisor will only be able to detect an inconsistency, and decide to restart the execution of both partitions from a valid previous context save point (rollback).

These means provide for verifying the consistency of the execution of the instances without waiting for the result at the end of its execution.

Advantageously, the means for recording exchanges between each of the instances of the executed application and the processor are configurable. This configuration comprises the size of a function call sequence; in other words one of the parameters corresponds to the number of calls to recorded consecutive functions of the hypervisor.

The scenario presented by way of example includes the following steps:
1. The scenario starts with the powering-up of the processing device (processor and motherboard); the powering-up involves resetting the processor;
2. The powering-up (1) is followed by a step for configuring the programmable memory (in particular periods for generating reset signals (signal 107 in FIG. 1) and pre-initialization signals (signal 106 in FIG. 1) and the hardware watchdog);
3. The processor is subjected to a first periodic reset;
4. After the reset, the hypervisor reads the context at the programmable memory;
5. The context is retrieved from the programmable memory and is transmitted to the processor in order that it is restored; and the execution of an application 201 is started;
6. An application is executed on the processor; this application makes a first call to a service X (Call_X) of the hypervisor;
7. The hypervisor carries out the action corresponding to the requested service X, executes health and consistency checks notably on the calling application, records the call with the aid of the means for recording exchanges and saves the processor context;
8. The hypervisor then hands control back to the calling application with the service X returned as requested;
9. The hypervisor sends a signal to the watchdog (located in programmable memory) to notify it that it is operating correctly;
10. The application executed on the processor calls a service Y (Call_Y) of the hypervisor;
10a. The hypervisor carries out the action corresponding to the requested service Y, executes health and consistency checks notably on the calling application, records the call with the aid of the means for recording exchanges, saves the processor context, and also sends a signal (signal 109 in FIG. 1) to the watchdog to notify it that it is operating correctly;
11. The hypervisor then hands control back to the calling application with the service Y returned as requested;
12. The hypervisor sends a signal (signal 109 in FIG. 1) to the watchdog (located in programmable memory) to notify it that it is operating correctly;
13. Execution of the application is suspended and the processing context of the processor is saved; these operations are carried out in anticipation of the next periodic reset, upon reception of the pre-initialization signal (signal 106 in FIG. 1) from the programmable electronic component 101. The hypervisor then keeps control until the reset signal is received (signal 107 in FIG. 1) causing the processor 100 to return to a known state;
14. The processor is subjected to a second periodic reset; as explained earlier, the period is configurable, and it can be, for example, between 1 millisecond and 10 seconds;
15. The context saved at step 13 is retrieved by the hypervisor;
16. This context is transmitted to the processor in order to be restored therein; the execution of the application then resumes its course.

For example, if the processor is locked during the first call (Call_X) to the hypervisor, then the execution of the application is blocked until the second periodic reset. After this reset, the last valid saved context (before the first reset, or during the cycle) is restored and execution of the application continues.

The two embodiments described below are applied for the case in which the hypervisor executes several instances of the same application.

According to one embodiment of the invention, the processor comprises a single processing core, and the instances of the application are executed in parallel on the said processing core.

In practice, a first instance is executed over a given time period, and its context saved. Execution of the instance is suspended in order that another instance is executed at its turn for a given time period. The execution context of that instance is also saved. When all the other instances have all been executed once, the context of the first instance is restored and the first instance continues its execution as before. Thus all the instances are executed in rotation.

This embodiment has the advantage of utilizing an inexpensive processor.

According to another embodiment, the processor includes a plurality of processing cores, and each of the instances of the application is executed on a different processing core.

This embodiment enables a faster execution of the instances than in the embodiment including a single processing core.

Another embodiment consists in using an additional timeout request signal 108 (in FIG. 1) allowing the hypervisor, on receiving the pre-initialization signal 106, to request from the programmable electronic component 101 a time delay in addition to the time period programmed by default in the programmable electronic component 101, before the reset signal 107 is actually received. This embodiment allows the hypervisor to have a little more time that is necessary when it executes critical uninterruptible operations before it can prepare itself for receiving the signal 107.

Another embodiment consists in using an additional signal 110 for activating the reset mechanism of the programmable electronic component 101. This embodiment provides for, when necessary, letting a processor board have time to start up before the hypervisor can correctly manage the reset mechanism of the programmable electronic component 101. According to a preferred embodiment, when this signal 110 is used, it may not be used to deactivate the reset mechanism of the programmable electronic component 101.

1. A device for improving the fault tolerance of a processor installed on a motherboard, said motherboard comprising memory units and a data input/output interface, said processor being able to execute at least one application (201), said device comprising:
a software layer, being a hypervisor, centralizing exchanges between the said processor and said application and implementing fault tolerance management mechanisms, and
a programmable electronic component forming an interface between the said processor on the one hand, and the memory units and the input/output interface on the other hand;
wherein one of the fault tolerance mechanisms implemented by the hypervisor is a function to return the processor to a known state, said function being called upon periodically according to a configurable period, the return of the processor to a known state being triggered by a reset signal transmitted by the programmable electronic component.

2. A device for improving fault tolerance according to claim 1, further comprising means for saving a processing context of the processor, and means for restoring the saved processing context, said means being used jointly to save a context before an execution of the function to return the processor to a known state and to restore said context after said function is executed, the means for saving the processing context of the processor being triggered when the processor receives a pre-initialization signal transmitted at a predetermined time period before the reset signal is transmitted.

3. A device for improving fault tolerance according to claim 1, in which the hypervisor is able to manage the simultaneous execution of several instances of said application.

4. A device for improving fault tolerance according to claim 3, further comprising:
means for recording exchanges between each of the instances of said executed application and of said processor, the means recording function call sequences being implemented by the hypervisor, and
means for comparing said recorded exchanges corresponding to the various instances.

5. A device for improving fault tolerance according to claim 1, wherein said processor comprises a single processing core.

6. A device for improving fault tolerance according to claim 1, wherein said processor comprises a plurality of processing cores.

7. A device for improving fault tolerance according to claim 3, wherein said processor comprises a plurality of processing cores, and wherein each instance is executed on a different processing core.

8. A device for improving fault tolerance according to claim 2, wherein the hypervisor further comprises a timeout function for transmitting a timeout request signal to a programmable electronic component in response to the reception of the pre-initialization signal, having the effect of obtaining a time delay in addition to the predetermined time period, before the reset signal is transmitted.

9. A device for improving fault tolerance according to claim 1, further comprising a watchdog mechanism, the hypervisor sending at a regular interval a signal to said watchdog to notify it that it is operating correctly, and, in the absence of such a signal at the end of a predefined time period, said watchdog resetting the processor executing the software part of the hypervisor.
